(19) United States
(12) Patent Application Publication
(10) Pub. No.: US 2018/0183754 A1
(43) Pub. Date: Jun. 28, 2018

(54) Address Allocation

(71) Applicant: HANGZHOU H3C TECHNOLOGIES CO., LTD., Zhejiang (CN)

(72) Inventor: Weiwei GUO, Beijing (CN)

(21) Appl. No.: 15/522,586

(22) PCT Filed: Oct. 27, 2015
(86) PCT No.: PCT/CN2015/092916

§ 371 Date: Apr. 27, 2017

(30) Foreign Application Priority Data
Oct. 28, 2014 (CN) 201410588051.0

(51) Int. Cl. H04L 29/12; H04L 12/46; H04W 76/12

(52) U.S. Cl. CPC H04L 61/2015; H04W 84/12; H04W 76/12; H04L 12/4633

(57) ABSTRACT

An access point (AP), deployed at a user network side, identifies a type of a packet received from a wireless client at the user network sid and performs a tunnel encapsulation on the packet if the packet is a Dynamic Host Configuration Protocol (DHCP) request packet to generate a tunnel encapsulated DHCP request packet. The AP sends the tunnel encapsulated DHCP request packet to an access controller (AC) deployed at a cloud platform side. The AP performs a tunnel de-capsulation on a DHCP response packet returned from the AC to generate a tunnel de-capsulated DHCP response packet, and sends the tunnel de-capsulated DHCP response packet to the wireless client. The tunnel de-capsulated DHCP response packet is loaded with address information allocated by the AC.

### BACKGROUND

In cloud platform based Wi-Fi (Wireless Fidelity) hotspots, different users located at different locations are collectively managed by a cloud platform. The cloud platform is a set of software system running at a data center, responsible for the management of user networks distributed across the country, including issue of configuration information, construction of big data platform by collecting various information, and uniform publication of advertisement, etc. Further, the authentication of wireless clients are collectively performed by the cloud platform, and the data traffic of the wireless client accessing the internet is directly forwarded by the internet gateway of the user network to the internet.

### BRIEF DESCRIPTION OF THE DRAWINGS

FIG. 1 illustrates an example of network of cloud platform based Wi-Fi hotspots;

FIG. 2 illustrates an example of the process flow of an address allocation method;

FIG. 3 illustrates an example of the structure of an access point (AP);

FIG. 4 illustrates an example of the structure of a device for address allocation;

FIG. 5 illustrates an example of the structure of an access controller (AC);

FIG. 6 illustrates an example of the structure of a device for address allocation.

### DETAILED DESCRIPTION OF THE EMBODIMENTS

In the cloud platform based Wi-Fi hotspots, each user network has its own internet gateway, and the internet gateway may also serve as a Dynamic Host Configuration Protocol (DHCP) server which allocates IP addresses for wireless clients in the user network. When the internet gateways in different user networks allocate IP addresses for wireless clients, some wireless clients, in different user networks, may be allocated with one same IP address since the internet gateways in different user networks are independent of each other and it is difficult for them to coordinate with each other. When these wireless clients with the one same IP address are experiencing an authentication process on the cloud platform, the cloud platform cannot distinguish one client from another, thus causing errors in the authentication.

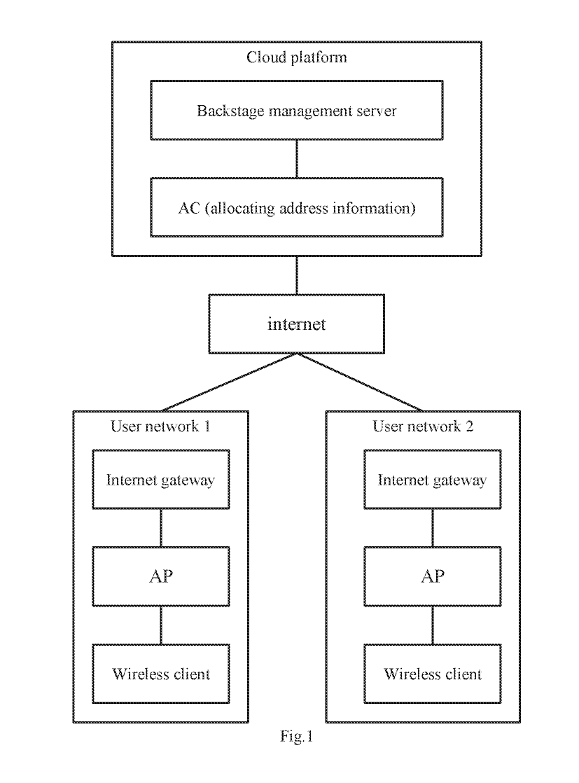

Based on the above, in one example of the present disclosure, a process for address allocation is provided, which can be applied in a network including wireless clients, access points (APs) and an access controller (AC), wherein the wireless clients and the APs are deployed in the user networks, and the AC is deployed in the cloud platform. FIG. 1 illustrates an example of the structure of network of cloud platform based Wi-Fi hotspots. In FIG. 1, different user networks (like user network 1 and user network 2) are located in different geographical areas and collectively managed by the cloud platform. The cloud platform is provided therein with an AC and a backstage server (such as authentication server or portal server etc.), and each of the user networks is provided with internet gateway(s), AP(s) and wireless client(s) etc.

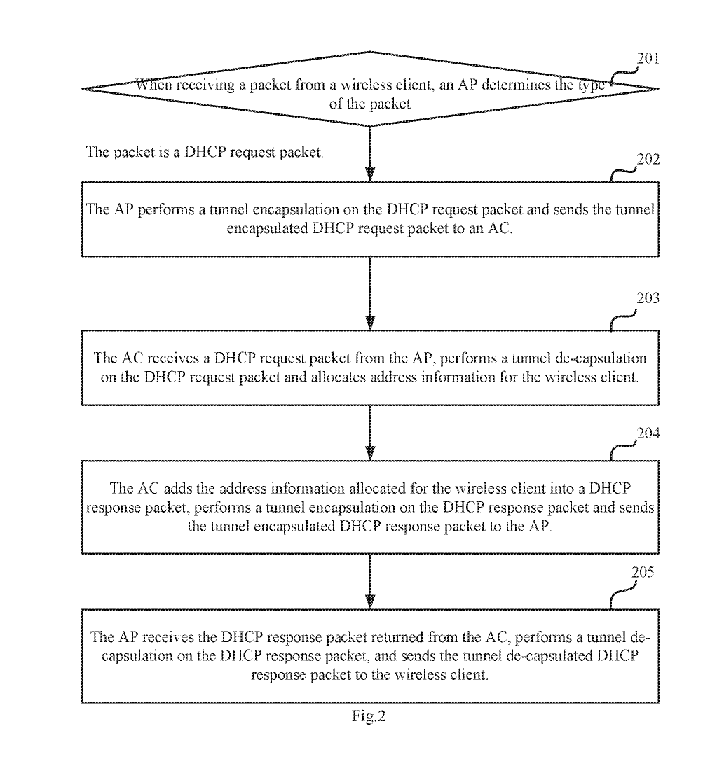

In the application as above, the process of address allocation comprises the following blocks as shown in FIG. 2:

At block 201, when one of the APs receives a packet from a wireless client, the AP determines the type of the packet. If the type of the packet is a DHCP request packet, then go to block 202. If it is not, then the AP sends the packet to the internet gateway of the user network where the AP is located to forward the packet.

At block 202, the AP performs a tunnel encapsulation on the DHCP request packet, and sends the tunnel encapsulated DHCP request packet to the AC. A Control And Provisioning of Wireless Access Points Protocol (CAPWAP) or Lightweight Access Point Protocol (LWAPP) may be created between the AP and the AC. When a CAPWAP tunnel is created, the AP performs a CAPWAP tunnel encapsulation on the DHCP request packet, that is, the DHCP request packet is encapsulated with a CAPWAP tunnel header. When an LWAPP tunnel is created, the AP performs a LWAPP tunnel encapsulation on the DHCP request packet, that is, the DHCP request packet is encapsulated with a LWAPP tunnel header.

In one example of the present disclosure, the AC may uniformly assign the IP addresses for the wireless clients in all the user networks. In other words, the IP addresses for the wireless clients in all the user networks are allocated by the AC which is deployed in the cloud platform but not by each of APs which are deployed in the user networks, and therefore each wireless client in the user networks managed by the AC may have an unique IP address, i.e., the same IP address would not be allocated to two different clients. Based on the above, for a packet sent from a wireless client, the AP may intercept the packet sent from the wireless client and determines whether the packet is a DHCP request packet. If it is a DHCP request packet, then the AP performs a tunnel encapsulation on the DHCP request packet and, through the tunnel between the AP and the AC, sends the DHCP request packet to the AC which assigns an IP address for the wireless client. If it is not a DHCP request packet, the AP directly sends the packet (as data traffic accessing the internet) to the internet gateway of the user network where the AP is located, and then the internet gateway forwards the packet to the internet.

At block 203, the AC receives the DHCP request packet from the AP, performs a tunnel de-capsulation on the DHCP request packet and allocates address information for the wireless client. The address information allocated by the AC includes but is not limited to: the user IP address allocated by the AC for the wireless client, the gateway IP address allocated by the AC for the internet gateway of the user network where the wireless client is located, and the DNS IP address allocated by the AC for the DNS (Domain Name System) server in the internet gateway of the user network where the wireless client is located. Further, since the DNS server is built inside the internet gateway, the DNS IP address allocated by the AC for the wireless client therefore may be the DNS IP address allocated by the AC for the DNS server in the internet gateway of the user network where the wireless client is located.

At block 204, the AC adds the address information allocated for the wireless client into a DHCP response packet, performs a tunnel encapsulation on the DHCP response packet and sends the tunnel encapsulated DHCP response packet to the AP.

Further, when a CAPWAP tunnel is created between the AP and the AC, the AC performs a CAPWAP tunnel de-capsulation on the DHCP request packet, that is, removing the CAPWAP tunnel header encapsulated on the DHCP request packet, and the AC performs a CAPWAP tunnel encapsulation on the DHCP response packet, that is, the DHCP response packet is encapsulated with a CAPWAP header. When a LWAPP tunnel is created between the AP and the AC, the AC performs LWAPP tunnel de-capsulation on the DHCP request packet, that is, removing the LWAPP tunnel header encapsulated on the DHCP request packet, and the AC performs LWAPP encapsulation on the DHCP response packet, that is the DHCP response packet is encapsulated with a LWAPP tunnel header.

When the AC receives a DHCP request packet from the AP, which may be equivalently considered as that the wireless client is directly connected with the AC in view of the AC, thus the AC may allocate a user IP address for the wireless client. When the AC allocates the user IP address for the wireless clients, the AC may directly multiplex the DHCP functional unit(s) built in the AC to allocate the user IP addresses for the wireless clients; or, the AC may use a DHCP server additionally deployed in the cloud platform to allocate the user IP addresses for the wireless clients; or, the AC may, based on commands from a cloud network administrator, allocate the user IP addresses designated by the cloud network administrator for the wireless clients.

In one example of the present disclosure, the wireless client makes use of the user IP address, the gateway IP address and the DNS IP address to access the internet, thus, in addition to adding the user IP address allocated for the wireless client into the DHCP response packet, the AC may also add into the DHCP response packet the gateway IP address allocated for the internet gateway of the user network where the wireless client is located, and the DNS IP address allocated for the DNS server in the internet gateway of the user network where the wireless client is located. Based on this, the AC may also acquire the gateway IP address allocated for the internet gateway of the user network where the wireless client is located, and the DNS IP address allocated for the DNS server in the internet gateway of the user network where the wireless client is located.

In one example of the present disclosure, when the AC in the cloud platform configures the gateway IP address and the DNS IP address for the internet gateway in the user network, here two examples are provided to illustrate the processes of the AC allocating the gateway IP address for the internet gateway of the user network where the wireless client is located, and the AC allocating the DNS IP address for the DNS server in the internet gateway of the user network where the wireless client is located.

EXAMPLE 1

When planning the user network, the network administrator instructs the AC to allocate one same gateway IP address for the internet gateways of all the user networks, such that the wireless clients in all the user networks are in one same IP network segment. In this case, the AC allocates one same gateway IP address for the internet gateways of all the user networks, and allocates one same DNS IP address which is in the same IP network segment with the corresponding gateway IP address for the DNS servers in the internet gateways in all the user networks. The AC sends the allocated gateway IP address and DNS IP address to the wireless client which sends a DHCP request packet.

Based on the planning of the network administrator, one IP network segment is configured on the AC in advance in order that the wireless clients in all the user networks are all in this IP network segment. The AC may select an IP address from the IP network segment randomly or according to choice of the user as the gateway IP address for the internet gateways of all the user networks, and similarly select an IP address from the IP network segment randomly or according to choice of the user as a DNS IP address of the DNS servers in the internet gateways in all the user networks. Further, the gateway IP address or the DNS IP address selected by the AC may be one same IP address in the IP network segment, or different IP addresses in the IP network segment. In the same way as above, in all the user networks, the wireless clients, the gateway IP addresses of the internet gateways, and the DNS IP addresses of the DNS servers are in the same IP network segment, which is the IP network segment configured on the AC by the network administrator.

After the AC allocates the same gateway IP address for the internet gateways of all the user networks and allocates the same DNS IP address for the DNS servers in the internet gateways in all the user networks, the AC may generate a configuration file which contains the gateway IP address and the DNS IP address allocated by the AC. In one example of the present disclosure, the internet gateway may be manually configured thereon with the configuration file including the gateway IP address and the DNS IP address to allow the internet gateway to obtain the gateway IP address and the DNS IP address.

Due to the above processing, in example I, the internet gateways of the user networks may use the same configuration file when delivery or installation such that the manual configuration for each of the internet gateways can be avoided, and such it is also less difficult to perform because it does not involve protocol interaction between the AC and the internet gateways.

### EXAMPLE 2

When planning the user networks, the network administrator instructs the AC to allocate different gateway IP addresses in different IP network segments for the internet gateways in all the user networks to allow the wireless clients in different user networks to be in different IP network segments. In such a way, the AC allocates the different gateway IP addresses in different IP network segments for the internet gateways in all the user networks, and allocates different DNS IP addresses in the same IP network segment with the corresponding gateway IP address for the DNS servers in the internet gateways in all the user networks. The AC sends, the gateway IP address allocated for the internet gateway in each of the user networks and the DNS IP address allocated for the DNS server in the corresponding interet gateway in each of the user networks, to the corresponding internet gateway and the wireless client sending a DHCP request packet in the user network.

Based on the planning of the network administrator, for each of the user networks, an IP network segment may be configured on the AC in advance in order that the wireless clients in different user networks are located in different IP network segments. For example, on the AC, IP network segment 1 is configured for user network 1, IP network segment 2 for user network 2, and wireless client(s) in user network 1 is/are located in IP network segment 1 and wireless client(s) in user network 2 is/are located in IP network segment 2.

For each of all the user networks, the AC may select an IP address from the IP network segment corresponding to the user network as the gateway IP address of the internet gateway in the user network randomly or according to choice of the user, and select an IP address from the

IP network segment corresponding to the user network as the DNS IP address of the DNS server in the internet gateway in the user network randomly or according to choice of the user. Further, the gateway IP address or the DNS IP address selected by the AC may be the same IP address in the IP network segment, or different IP addresses in the IP network segment.

In such a manner as above, the wireless client(s), the gateway IP address of the internet gateway and the DNS IP address of the DNS server of one same user network are located in the same IP network segment, and the wireless client(s), the gateway IP address of the internet gateway and the DNS IP address of the DNS server of each of different user networks are located in different IP network segments. For example, the wireless client(s), the gateway IP address of the internet gateway and the DNS 1P address of the DNS server in user network 1 are located in IP network segment 1, and the wireless client(s), the gateway IP address of the internet gateway and the DNS IP address of the DNS server in user network 2 are located in IP network segment 2.

After the AC allocates the gateway IP address for the internet gateway of each of the user networks and allocates the DNS IP address for the DNS server in the internet gateway, the AC may, through a management protocol packet, send, the gateway IP address allocated for the internet gateway for each of the user networks and the DNS IP address allocated for the DNS server in the corresponding internet gateway, to the internet gateway of the user network. The gateway IP address and DNS IP address are sent to the internet gateway in the user network in the following ways but not limited to: (i) the AC sends the gateway IP address and the DNS IP address to the internet gateway in a packet of management protocol like Simple Network Management Protocol (SNMP); (ii) the internet gateway automatically finds the AC and connects itself to the AC, and is subjected to configuration from the AC, such as a CAPWAP tunnel or LWAPP tunnel created between the AC and the internet gateway, and then the AC sends the gateway IP address and the DNS IP address to the internet gateway in a packet of management protocol like CAPWAP or LWAPP.

In such a way as above, in example 2, the wireless clients in multiple user networks are configured with different IP network segments, thus greatly improving the flexibility of networking such that the cloud platform based Wi-Fi hotspot network can be applied in more and wider applications.

Further, with respect to example 1 and example 2, in the example 2, packet interaction based on management protocol is required between the AC and the internet gateway, thus the example 2 may be applicable when the. AC and the internet gateway belong to the same vendor; and in the example 1, the packet interaction based on management protocol is not performed between the AC and the internet gateway, thus the example 1 may be applicable when the AC and the internet gateway are from different vendors or the AC and the internet gateway are from the same vendor. Generally, when the AC and the internet gateway are from the same vendor, the solution as in the example 2 is adopted; when the AC and the internet gateway are from different vendors, the solution as in the example 1 is adopted.

At block 205, the AP receives the DHCP response packet returned from the AC, performs a tunnel de-capsulation on the DHCP response packet, and sends the tunnel de-capsulated DHCP response packet to the wireless client.

Further, when a CAPWAP tunnel is created between the AP and the AC, the AP performs a CAPWAP tunnel de-capsulation on the DHCP response packet, that is, removing the CAPWAP tunnel header encapsulated on the DHCP response packet. When a LWAPP tunnel is created between the AP and the AC, the AP performs a LWAPP tunnel de-capsulation on the DHCP response packet, that is, removing the LWAPP tunnel header encapsulated on the DHCP response packet.

In such a way as above, the DHCP response packet may be sent to the wireless client, and the DHCP response packet is loaded with the user IP address, the gateway IP address and the DNS IP address, with which the wireless client may access the internet.

Based on the above technical solution, by allocating the IP addresses for wireless clients in all the user networks through the AC deployed on the cloud platform, the allocation by the internet gateway can be avoided, and it is guaranteed that each of the wireless clients has a unique IP address, and the problem of multiple wireless clients sharing one the same IP address can be overcome, and the cloud platform may identify all the wireless clients based on the different allocated IP addresses thereby the authentication system is rid of disturbances and authentication error can be avoided.

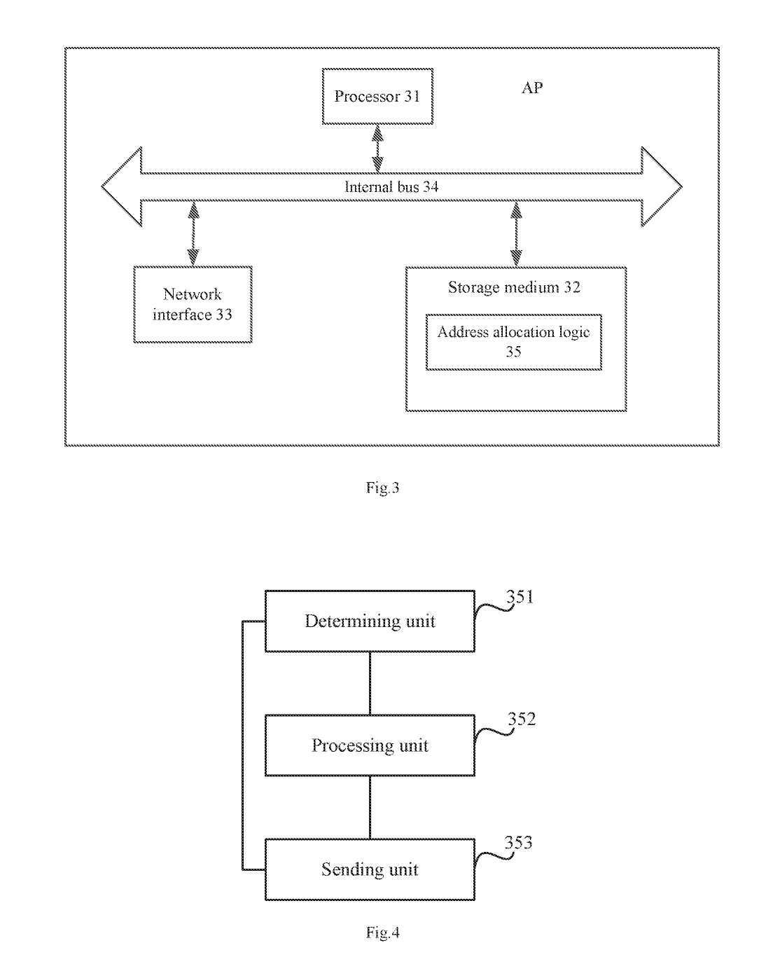

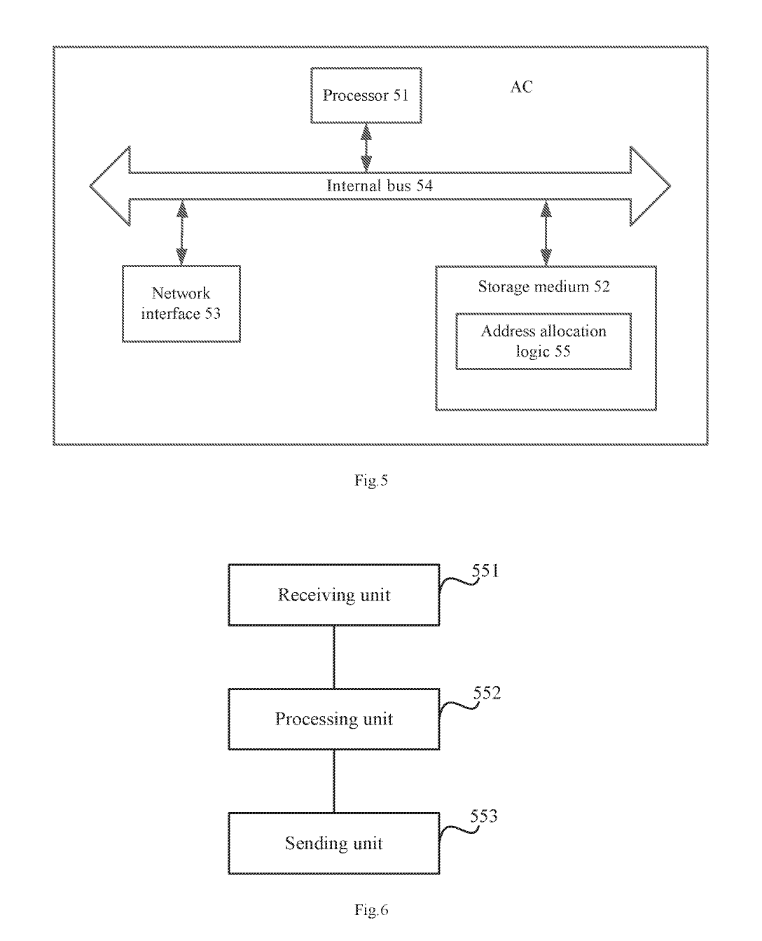

FIG. 3 illustrates a hardware architecture of an AP in an example of the present disclosure, in which the AP is applied in a network comprising the AP itself, a wireless client(s) and an AC, and the wireless client and the AP are deployed in the user network and the AC is deployed in a cloud platform. As shown in FIG. 3, the AP may comprise a processor 31, a storage medium 32, a network interface 33 and an internal bus 34, and the AP is being operated thereon with an address allocation logic 35. Further, as shown in FIG. 4, in view of function, the address allocation logic 35 may comprise a determining unit 351, a processing unit 352 and a sending unit 353, wherein:

a determining unit 351, configured to, when receiving a packet from the wireless client, determine the type of the packet;

a processing unit 352, configured to, when the type of the packet is a DHCP request packet, perform a tunnel encapsulation on the DHCP request packet; and perform a tunnel de-capsulation on a DHCP response packet when receiving the DHCP response packet returned from the AC;

a sending unit 353, configured to, after the DHCP request packet is tunnel encapsulated, send the tunnel encapsulated DHCP request packet to the AC; and after the DHCP response packet is tunnel de-capsulated, send the tunnel de-capsulated DHCP response packet to the wireless client; in which the tunnel de-capsulated DHCP response packet is loaded with address information allocated by the AC.

In an example of the present disclosure, the user network is further deployed with an internet gateway. The sending unit 353 is also configured to send the packet to the internet gateway for forwarding if the type of the packet is not a DHCP request packet after the determining unit 351 determines the type of the packet.

In an example of the present disclosure, the address information allocated by the AC includes: the user IP address allocated by the AC for the wireless client, the gateway IP address allocated by the AC for the internet gateway of the user network where the wireless client is located, and the DNS IP address allocated by the AC for the DNS server in the internet gateway of the user network where the wireless client is located.

Here gives an example of software implementation illustrating how the AP which operates the address allocation logic 35 executes the address allocation logic 35. In this example, the address allocation logic 35 means computer-readable instructions stored in the storage medium 32. When the AP which operates the address allocation logic 35 executes the address allocation logic 35, by invoking the instructions of corresponding functional modules of the address allocation logic 35 stored on the storage medium 32 of the AP, the processor 31 of the AP performs:

when receiving a packet from the wireless client of the user network side, determining the type of the packet;

if the type of the packet is a DHCP request packet, performing a tunnel encapsulation on the DHCP request packet, and sending the tunnel encapsulated DHCP request packet to the AC deployed at the cloud platform side;

when receiving a DHCP response packet returned from the AC, performing a tunnel de-capsulation on the DHCP response packet, and sending the tunnel de-capsulated DHCP response packet to the wireless client, in which the tunnel de-capsulated DHCP response packet is loaded with the address information allocated by the AC,

By invoking the instructions of the corresponding functional modules of the address allocation logic 35 stored on the storage medium 32, the processor 31 further performs: when the type of the packet is not a DHCP request packet, sending the packet to the internet gateway deployed at the user network side for forwarding.

The address information allocated by the AC includes: the user IP address allocated by the AC for the wireless client, the gateway IP address allocated by the AC for the gateway of the user network where the wireless client is located, and the DNS IP address allocated by the AC for the DNS server in the internet gateway of the user network where the wireless client is located.

FIG. 5 illustrates a schematic of hardware architecture of AC in an example of the present disclosure, in which the AC is applied in a network including the AC itself, (a) wireless client(s) and an AP, and the wireless client and the AP are deployed in the user network, and the AC is deployed in the cloud platform. As shown in FIG. 5, the AC may comprise a processor 51, a storage medium 52, a network interface 53 and an internal bus 54, and the AC is being operated with an address allocation logic 55. Further, as shown in FIG. 5, in view of function, the address allocation logic 55 may comprise a receiving unit 551, a processing unit 552 and a sending unit 553, in which:

a receiving unit 551, configured to receive a. DHCP request packet from the AP; in which, the DHCP request packet is sent after the AP performs a tunnel encapsulation on the DHCP request packet when the AP determines that the type of the packet from the wireless client is a DHCP request packet;

a processing unit 552, configured to tunnel de-capsulate the DHCP request packet and allocate address information for the wireless client, and add the address information into the DHCP response packet and tunnel encapsulate the DHCP response packet;

a sending unit 553, configured to send the tunnel encapsulated DHCP response packet to the AP.

In an example of the present disclosure, the user network is further deployed with a internet gateway; and the processing unit 552 is further configured to allocate one same gateway IP address for the internet gateways of all the user networks and allocate one same DNS IP address in the same IP network segment with the corresponding gateway IP address for the DNS servers in the interact gateways of all the user networks; and the sending unit 553 is further configured to send the allocated gateway IP address and the allocated DNS IP address to the wireless client sending the DHCP request packet; or

the processing unit 552 is further configured to allocate different gateway IP addresses in different IP network segments for the internet gateways in all the user networks and allocate different DNS IP addresses in the same IP network segment with the corresponding gateway IP address for the DNS servers in the internet gateways in all the user networks; the sending unit 553 is further configured to, send, the gateway IP address allocated for the internet gateway in each of the user networks and the DNS IP address allocated for the DNS server in the corresponding internet gateway, to the corresponding internet gateway and the wireless client sending the DHCP request packet in the user network.

In one example of the present disclosure, the address information allocated by the AC includes the user IP address allocated by the AC for the wireless client, the gateway IP address allocated by the AC for the internet gateway of the user network where the wireless client is located, and the DNS IP address allocated by the AC for the DNS server in the internet gateway of the user network where the wireless client is located.

Here gives an example of software implementation further illustrating how the AC which operates the address allocation logic 55 executes the address allocation logic 55, in which the address allocation logic 55 means computer-readable instructions stored in the storage medium 52. When the AC which operates the address allocation logic 55 executes the address allocation logic 55, by invoking the instructions of corresponding functional modules of the address allocation logic 55 stored on the storage medium 52 of the AC, the processor 51 of the AC performs the following:

receiving a DHCP request packet from the access point AP deployed at the user network side; in which, the DHCP request packet is sent after the AP performs a tunnel encapsulation on the DHCP request packet when the AP determines that the packet from the wireless client at the user network side is a DHCP request packet;

performing a tunnel de-capsulation on the DHCP request packet, and allocating address information for the wireless client and adding the address information into the DHCP response packet; and

performing a tunnel encapsulation on the DHCP response packet, and sending the tunnel encapsulated DHCP response packet to the AP.

By invoking the instructions of corresponding functional modules of the address allocation logic 55 stored on the storage medium 52, the processor 51 further performs: allocating one same gateway IP address for the internet gateways in all the user networks and allocating one same DNS IP address in the same IP network segment with the corresponding gateway IP address for the DNS servers in the internet gateways in all the user networks; and sending the allocated gateway IP address and DNS IP address to the wireless client sending the DHCP request packet; or,

allocating different gateway IP addresses in different IP network segments for the internet gateways in all the user networks, and allocating different DNS IP addresses in the same IP network segment with the corresponding gateway IP address for the DNS servers in the internet gateways of all the user networks; and sending the allocated gateway IP address for the internet gateway in each of the user networks and the allocated DNS IP address for the DNS server in the corresponding internet gateway to the corresponding internet gateway and the wireless client sending the DHCP request packet in the user network.

The address information allocated by the AC includes: the user IP address allocated by the AC for the wireless client, the gateway IP address allocated by the AC for the internet gateway of the user network where the wireless client is located, and the DNS IP address allocated by the AC for the DNS server in the internet gateway of the user network where the wireless client is located.

The foregoing disclosure is merely illustrative of certain examples but are not intended to limit the disclosure, and any modifications, equivalent substitutions, adaptations, thereof made without departing from the spirit and scope of the disclosure shall be encompassed in the claimed scope of the appended claims.

1. A method for address allocation, comprising:
identifying, by an access point (AP) deployed at a user network side, the type of a packet received from a wireless client at the user network side;
performing, by the AP, a tunnel encapsulation on the packet if the packet is a Dynamic Host Configuration Protocol (DHCP) request packet to generate a tunnel encapsulated DHCP request packet, and sending the tunnel encapsulated DHCP request packet to an access controller (AC) deployed at a cloud platform side; and
performing, by the AP, a tunnel de-capsulation on a DHCP response packet returned from the AC to generate a tunnel de-capsulated DHCP response packet, and sending the tunnel de-capsulated DHCP response packet to the wireless client, wherein the tunnel de-capsulated DHCP response packet is loaded with address information allocated by the AC.

2. The method according to claim 1, further comprises:
sending, by the AP, the packet to an internet gateway deployed at the user network side for forwarding if the packet is not a DHCP request packet.

3. The method according to claim 1, wherein the address information allocated by the AC comprises:
a user IP address allocated by the AC for the wireless client,
a gateway IP address allocated by the AC for the internet gateway of the user network in which the wireless client is located, and
a Domain Name System (DNS) IP address allocated by the AC for a DNS server in the internet gateway of the user network in which the wireless client is located.

4. A method for address allocation, comprises:
receiving, by an access controller (AC) deployed at a cloud platform side, a Dynamic Host Configuration Protocol (DHCP) request packet from an access point (AP) deployed at a user network side, wherein the DHCP request packet is a tunnel encapsulated DHCP request packet which is generated by the AP performing a tunnel encapsulation on a DHCP request packet from a wireless client at the user network side;
performing, by the AC, a tunnel de-capsulation on the tunnel encapsulated DHCP request packet, allocating address information for the wireless client and adding the address information into a DHCP response packet for responding the tunnel encapsulated DHCP request packet;
performing, by the AC, a tunnel encapsulation on the DHCP response packet to generate a tunnel encapsulated DHCP response packet; and
sending, by the AC, the tunnel encapsulated DHCP response packet to the AP.

5. The method according to claim 4, further comprises:
allocating, by the AC, one same gateway IP address for internet gateways of all user networks, and one same DNS IP address in the same IP network segment with corresponding gateway IP address for Domain Name System (DNS) servers in the internet gateways of all user networks; and
sending, by the AC, the allocated gateway IP address and DNS IP address to the wireless client from which the DHCP request packet is sent; or,
allocating, by the AC, different gateway IP addresses in different IP network segments for internet gateways of all user networks, and different DNS IP addresses in the same IP network segment with corresponding gateway IP address to DNS servers in the internet gateways of all the user networks; and
sending, by the AC, the gateway IP address and the DNS IP address allocated for the user network in which the wireless client sending the DHCP request packet is located, to the internet gateway of the user network and the wireless client.

6. The method according to claim 4, wherein the address information allocated by the AC includes:
a user IP address allocated by the AC for the wireless client,
a gateway IP address allocated by the AC for the internet gateway of the user network in which the wireless client is located, and
a DNS IP address allocated by the AC for the DNS server in the internet gateway of the user network in which the wireless client is located.

7. An access point (AP), deployed at a user network side, including a processor, wherein, by invoking instructions of corresponding functional modules of an address allocation logic stored on a storage medium, the processor is caused to:
identify the type of a packet received from a wireless client at the user network side;
perform a tunnel encapsulation on the packet if the packet is a Dynamic Host Configuration Protocol (DHCP) request packet to generate a tunnel encapsulated DHCP request packet, and send the tunnel encapsulated DHCP request packet to an access controller (AC) deployed at a cloud platform side; and
perform a tunnel de-capsulation on a DHCP response packet returned from the AC to generate a tunnel de-capsulated DHCP response packet, and send the tunnel de-capsulated DHCP response packet to the wireless client, wherein the tunnel de-capsulated DHCP response packet is loaded with address information allocated by the AC.

8. The AP according to claim 7, wherein the instructions further cause the processor to:
send the packet to an internet gateway deployed at the user network side for forwarding if the packet is not a DHCP request packet.

9. The AP according to claim 7, wherein the address information allocated by the AC includes:
a user IP address allocated by the AC for the wireless client,
a gateway IP address allocated by the AC for the internet gateway of the user network in which the wireless client is located, and
a Domain Name System (DNS) IP address allocated by the AC for the DNS server in the internet gateway of the user network in which the wireless client is located.

10. An access controller (AC), deployed at a cloud platform side, including a processor, wherein, by invoking instructions of corresponding functional modules of an address allocation logic stored on a storage medium, the processor is caused to:
receive a Dynamic Host Configuration Protocol (DHCP) request packet from an access point (AP) deployed at a user network side, wherein the DHCP request packet is a tunnel encapsulated DHCP request packet which is generated by the AP performing a tunnel encapsulation on a DHCP request packet from a wireless client at the user network side;
perform a tunnel de-capsulation on the tunnel encapsulated DHCP request packet, allocate address information for the wireless client and add the address information into a DHCP response packet for responding the tunnel encapsulated DHCP request packet; and
perform a tunnel encapsulation on the DHCP response packet to generate a tunnel encapsulated DHCP response packet, and send the tunnel encapsulated DHCP response packet to the AP.

11. The AC according to claim 10, wherein the instructions further cause the processor to:
allocate one same gateway IP address for internet gateways of all user networks, and one same Domain Name System (DNS) IP address in the same IP network segment with corresponding gateway IP address for DNS server in the internet gateway of all user networks; and
send the allocated gateway IP address and DNS IP address to the wireless client from which the DHCP request packet is sent; or,
allocate different gateway IP addresses in different IP network segments for internet gateways of all user networks, and different DNS IP addresses in the same IP network segment with corresponding gateway IP address for DNS servers in the internet gateways of all user networks; and
send the gateway IP address and the DNS IP address allocated for the user network in which the wireless client sending the DHCP request packet is located, to the internet gateway of the user network and the wireless client.

12. The AC according to claim 10, wherein address information allocated by the AC comprises:
a user IP address allocated by the AC for the wireless client,
a gateway IP address allocated by the AC for the internet gateway of the user network in which the wireless client is located, and
a DNS IP address allocated by the AC for the DNS server in the internet gateway of the user network in which the wireless client is located.

13. A non-transitory computer readable storage medium, storing thereon machine readable instructions, which are executable by a processor to:
receive a Dynamic Host Configuration Protocol (DHCP) request packet from an access point (AP) deployed at a user network side, wherein the DHCP request packet is a tunnel encapsulated DHCP request packet which is generated by the AP performing a tunnel encapsulation on a DHCP request packet from a wireless client at the user network side;
perform a tunnel de-capsulation on the tunnel encapsulated DHCP request packet, allocate address information for the wireless client and add the address information into a DHCP response packet for responding the tunnel encapsulated DHCP request packet; and
perform a tunnel encapsulation on the DHCP response packet to generate a tunnel encapsulated DHCP response packet, and send the tunnel encapsulated DHCP response packet to the AP.

14. The non-transitory computer readable storage medium according to claim 13, wherein the instructions further cause the processor to:
allocate one same gateway IP address for internet gateways of all user networks, and one same Domain Name System (DNS) IP address in the same IP network segment with corresponding gateway IP address for DNS server in the internet gateway of all user networks; and
send the allocated gateway IP address and DNS IP address to the wireless client from which the DHCP request packet is sent; or,
allocate different gateway IP addresses in different IP network segments for internet gateways of all user networks, and different DNS IP addresses in the same IP network segment with corresponding gateway IP address for DNS servers in the internet gateways of all user networks; and
send the gateway IP address and the DNS IP address allocated for the user network in which the wireless client sending the DHCP request packet is located, to the internet gateway of the user network and the wireless client.

15. The non-transitory computer readable storage medium according to claim 13, wherein the address information allocated by the AC comprises:
a user IP address allocated by the AC for the wireless client,
a gateway IP address allocated by the AC for the internet gateway of the user network in which the wireless client is located, and
a DNS IP address allocated by the AC for the DNS server in the internet gateway of the user network in which the wireless client is located.
